(19) United States
(12) Patent Application Publication
(10) Pub. No.: US 2010/0038067 A1
(43) Pub. Date: Feb. 18, 2010

(54) CLIMATE CONTROL SYSTEM

(76) Inventor: James P. Flynn, Smithtown, NY (US)

Correspondence Address: ADVANTIA LAW GROUP, 9035 SOUTH 1300 EAST, SUITE 200, SANDY, UT, 84094, US

(21) Appl. No.: 12/582,870

(22) Filed: Oct. 21, 2009

Related U.S. Application Data
(63) Continuation-in-part of application No. 11/306,140, filed on Dec. 16, 2005.

(51) Int. Cl. B60H 1/00

(52) U.S. Cl. 165/202

(57) ABSTRACT

There is a climate control system for open-seat vehicles. The climate control system includes a control module and a heating module operationally coupled to an interface portion of the open-seat vehicle. The heating module includes a device for converting power to heat when activated. The heating module also includes a timing module configured to automatically switch the heating module operation from a first heating mode to a second heating mode that is of a lower heat flow than the first heating mode after a programmed time elapses from actuation of the first heating mode. The control module is configured to be coupled to the handles and accessible therefrom. The climate control system also includes a retrofit kit configured to be added to a open-seat vehicle. The retrofit kit may also include mounting devices for mounting the components and modules to the open-seat vehicle.

### CROSS-REFERENCE TO RELATED APPLICATIONS

This application is a Continuation-in-Part Application of, under 35 U.S.C. §121, and claims priority to, under 35 U.S.C. §121, U.S. Non-Provisional application Ser. No. 11/306,140, entitled Cycle Heat and Cool, by James P. Flynn, filed on Dec. 16, 2005, which reference is incorporated herein by reference in its entirety.

### BACKGROUND OF THE INVENTION

1. Field of the Invention

The present invention relates to climate control systems, specifically to a climate control system for motorcycles.

2. Description of the Related Art

HVAC is an acronym that stands for the closely related functions of “Heating, Ventilating, and Air Conditioning”—the technology of indoor environmental comfort. HVAC system design is a major sub-discipline of mechanical engineering, based on the principles of thermodynamics, fluid mechanics, and heat transfer. Refrigeration is sometimes added to the field's abbreviation as HVAC&R or HVACR, or ventilating is dropped as in HACR (such as the designation of HACR-rated circuit breakers). HVAC is particularly important in the design of medium to large industrial and office buildings such as skyscrapers and in marine environments such as aquariums, where safe and healthy building conditions are regulated with temperature and humidity, as well as “fresh air” from outdoors.

There are different types of standard heating systems. Central heating is often used in cold climates to heat private houses and public buildings. Such a system contains a boiler, furnace, or heat pump to heat water, steam, or air, all in a central location such as a furnace room in a home or a mechanical room in a large building. The system also contains either ductwork, for forced air systems, or piping to distribute a heated fluid and radiators to transfer this heat to the air. The term radiator in this context is misleading since most heat transfer from the heat exchanger is by convection, not radiation. The radiators may be mounted on walls or buried in the floor to give under-floor heat.

In boiler fed or radiant heating systems, all but the simplest systems have a pump to circulate the water and ensure an equal supply of heat to all the radiators. The heated water can also be fed through another (secondary) heat exchanger inside a storage cylinder to provide hot running water.

Forced air systems send heated air through ductwork. During warm weather the same ductwork can be used for air conditioning. The forced air can also be filtered or put through air cleaners. Heating can also be provided from electric, or resistance heating using a filament that becomes hot when electricity is caused to pass through it. This type of heat can be found in electric baseboard heaters, portable electric heaters, and as backup or supplemental heating for heat pump (or reverse heating)>system. Some improvements have been made in the field. Examples of references related to the present invention are described below, and the supported teachings of each reference are incorporated by reference herein:

U.S. Pat. No. 4,555,911, issued to Kusisto, discloses a air conditioner system for bicycles and other vehicles, the system using a wheel of the vehicle as a source of power, air flow through an ice chamber being useable in the system as an optional further coolant.

U.S. Pat. No. 4,471,209, issued to Hollander, discloses an electrically heated hand grips for the handle bars of vehicles such as motorcycles and the like that are fabricated with an inner cylindrical sleeve member molded of synthetic plastic material. An electrical resistance heater wire coil is embedded in each sleeve. The inner surface of said the sleeve includes a plurality of circumferentially spaced and axially extending ribs, and the outer surface of said the sleeve includes a longitudinally extending land and groove pattern. The spaces between the ribs on the inner surface and the grooves on the outer surface of the sleeve have radially coextensive, overlapping circumferential portions where the sleeve is of minimum wall thickness. The resistance wire coil is disposed within said the sleeve member such that it is spaced a substantial distance from the inner surface of the ribs and the outer surface of the lands. The diameter of the heater wire is not less than the minimum wall thickness of the sleeve. The heated hand grip also includes an outer sheath of resilient material which is molded onto and encapsulates the inner sleeve. Electrical lead wires are connected to the ends of said electrical resistance wires.

U.S. Patent Application No. 2004/0011777, by Richlen, discloses a heated motorcycle handgrip securable to a motorcycle handlebar and including a grip housing that has a first end adapted to receive the handlebar, and a second end opposite the first end. The grip housing includes a heating element that is operable to provide a heat output, and a heater control dial is coupled to the second end of the handgrip to control the heat output of the heating element.

The inventions heretofore known suffer from a number of disadvantages which include being limited in application, being limited in versatility, being limited in use, being unduly complex, being expensive, being ineffective, being inefficient, and being difficult to use.

What is needed is a climate control system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available climate control systems. Accordingly, the present invention has been developed to provide an efficient and effective climate control systems for motorcycles.

In one embodiment of the invention, there is a climate control system for open-seat vehicles. The climate control system may include a control module coupled to the open-seat vehicle and accessible to a user. The climate control system may also include a heating module operationally coupled to an interface portion of the open-seat vehicle and functionally coupled to the control module, such that the control module may activate the heating module. The heating module may include a device for converting power to heat when activated. The heating module may also include a timing module configured to automatically switch the heating module operation from a first heating mode to a second heating mode that is of a lower heat flow than the first heating mode after a programmed time elapses from actuation of the first heating mode. The heating module may include a cooling module coupled to an interface portion of the open-seat vehicle and functionally coupled to the control module such that the control module may activate the cooling module. The cooling module may include a device for utilizing power to remove heat.

The interface portion may be selected from the group consisting of handles, seat, and foot rest. The control module may be coupled to the handles and accessible therefrom. The climate control system may also include a retrofit kit configured to be added to a open-seat vehicle. The retrofit kit may also include mounting devices for mounting the control module to handles of the open-seat vehicle and mounting devices for mounting the heating and cooling modules to interface portions of the open-seat vehicle.

In another embodiment of the invention, there is a retro-fit climate control system for open-seat vehicles. The retro-fit climate control system may include a control module coupled to the open-seat vehicle and accessible to a user. The kit may also include a heating module operationally coupled to an interface portion of the open-seat vehicle and functionally coupled to the control module such that the control module may activate the heating module, the heating module including a device for converting power to heat when activated. The kit may include a timing module configured to automatically switch the heating module operation from a first heating mode to a second heating mode that is of a lower heat flow than the first heating mode after a programmed time elapses from actuation of the first heating mode. The kit may include a cooling module coupled to an interface portion of the open-seat vehicle and functionally coupled to the control module such that the control module may activate the cooling module. The cooling module may include a device for utilizing power to remove heat. The retrofit kit may also include mounting devices for mounting the control module to handles of the open-seat vehicle and mounting devices for mounting the heating and cooling modules to interface portions of the open-seat vehicle. The interface portion may be selected from the group consisting of handles, seat, and foot rest. The control module may be coupled to the handles and accessible therefrom.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a side view of a motorcycle including a climate control system according to one embodiment of the invention; and

FIG. 2 is a block diagram showing a climate control system according to one embodiment of the invention; and

FIG. 3 is a component diagram illustrating a climate control system according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Turning to the figures, there is illustrated a climate control system 100 for motorcycles according to one embodiment of the invention. There is illustrated a control module 110 coupled to the motorcycle 99 and accessible to a user. There is also shown a heating module 120 coupled to an interface portion, or interface module 104 of the motorcycle 99 and functionally coupled to the control module 110. Further, in the illustrated embodiment, there is a cooling module 130 coupled to an interface portion 104 of the motorcycle 99 and functionally coupled to the control module 110. The illustrated interface portions 104 are handles 106, seat 104, and foot rest 104. The illustrated control module 110 is coupled to the handles 104 and accessible therefrom. An interface portion 104 may be any portion of a motorcycle 99 to which a user may desire to come in substantial contact while using the motorcycle 99. As used in this application, the term motorcycle 99 includes other open vehicles such as but not limited to ATV and snowmobiles.

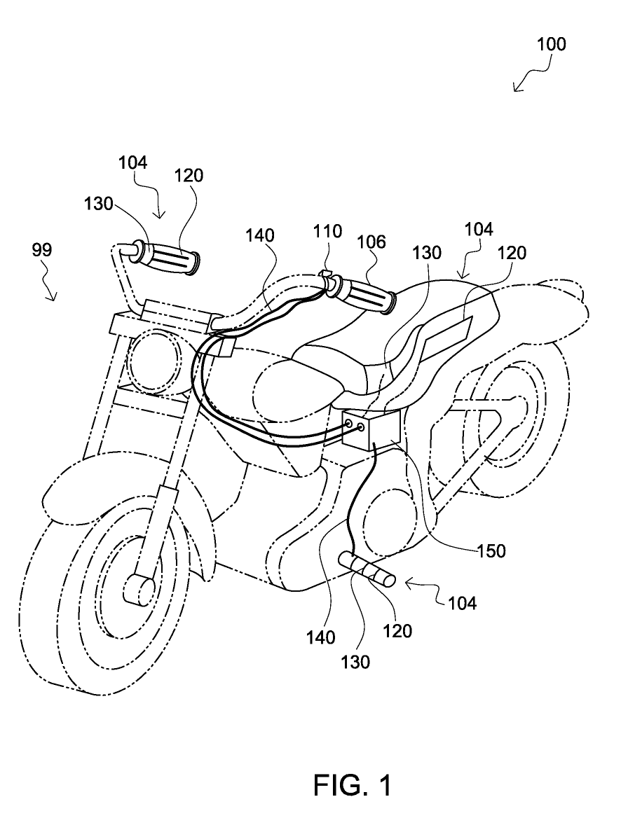

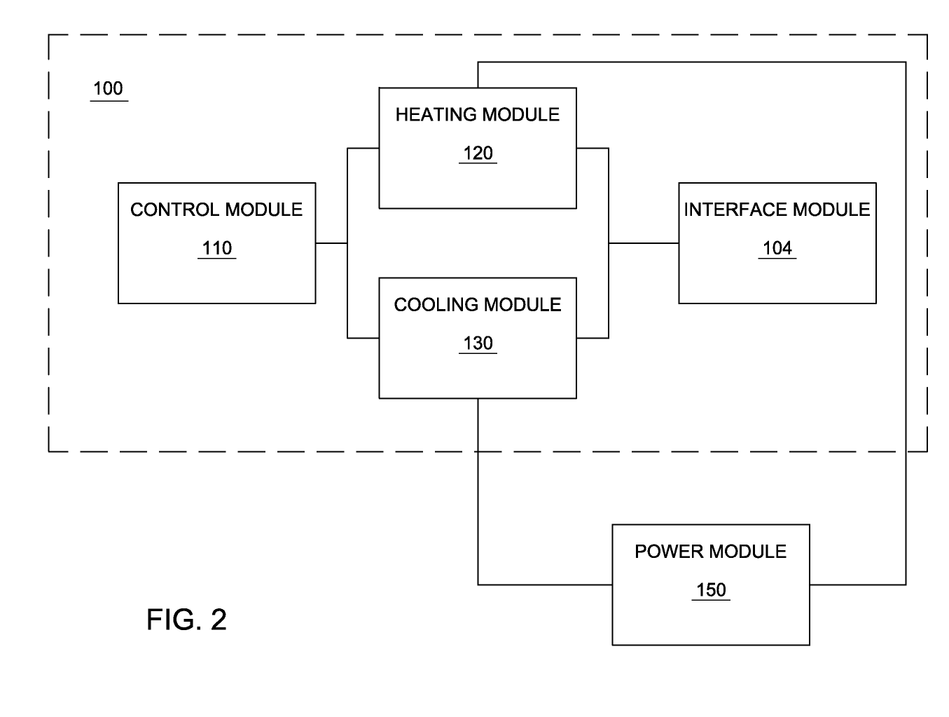

In one embodiment, the heating module 120 comprises a first heating mode and a second heating mode that is of a lower heat flow than the first heating mode wherein the control module 110 automatically switches to the second heating mode after a programmed time elapses from actuation of the first heating mode. In another embodiment, the system 100 comprises a retrofit kit configured to be added to a motorcycle 99. In one embodiment, as shown in FIG. 1, the control module 110 may couple to and direct the power module 150 through wires 140 which then may activate and/or direct activation of the heating and/or cooling modules 120 and/or 130 through >wires 140. In another example, the modules 110, 120, 130, and 150 may be functionally coupled as shown in FIG. 2. It is envisioned that there are a multiplicity of modes of connecting and controlling modules of the system 100, and such are within the scope of the invention.

In yet another embodiment, the control module 110 may include physical and/or electric controls configured to actuate, activate, switch, and/or adjust functioning of the heating and/or cooling modules. Embodiments include buttons, switches, connections, and twist selectors. In one example, a control module 110 sends an electrical signal to a heating and/or cooling module in response to actuation by a user. It is appreciated that such devices are commonly known in the art and varieties of such are plethoric. The heating module 120 may include one or more heat transducers, such as but not limited to: heat producing electrical components, heat conducting materials selectably coupleable to a hot item, heat pumps, and/or heated fluid circulators. The cooling module 130 may include one or more cold transducers, such as but not limited to: heat removing electrical components, heat conducting materials selectably coupleable to a cold item, heat pumps, and/or cooled fluid circulators.

In one embodiment, there is a series of heating elements incorporated into a motorcycle's 99 handle grips 106, seat, and foot rests. There is a two-position switch in the vicinity of either handlebar and wired to the heating elements, drawing power from a power element, such as drawing electrical power from an alternator coupled to a motor of the motorcycle. The switch includes a symbol for heat and a symbol for cool. When activated in heat mode, the heating elements are activated in a “high” mode and warm the interface portions. After a predetermined interval, the system changes from the “high”>mode to the “low” mode via timing circuit, with the purpose of maintaining a desired temperature range. After another period of time, the heating element may automatically turn off.

In a cool mode, selected through the control module 110, one or more interface portions 104 are cooled by an evaporator, which transports cool air from an air-cooled condenser with a compressor driven by the engine of the motorcycle 99. The cool mode may or may not include a multi-stage mode similar to that of the heat mode.

In one example, the system 100 is incorporated into a design of a newly manufactured motorcycle 99. In one example, the system is an aftermarket accessory, a retro-fit kit, configured to be installed in an existing motorcycle 99.

In operation, a user may use a motorcycle 99 and may be riding and/or coupled to the motorcycle 99 at one or more interface portions 104. The user may then select and control temperature flow through one or more interface portions 104. The user may initiate a sequence of heating and/or cooling steps whereby the user may experience a series of heating and/or cooling steps configured to enhance the comfort of the user without requiring the user to individually initiate each step.

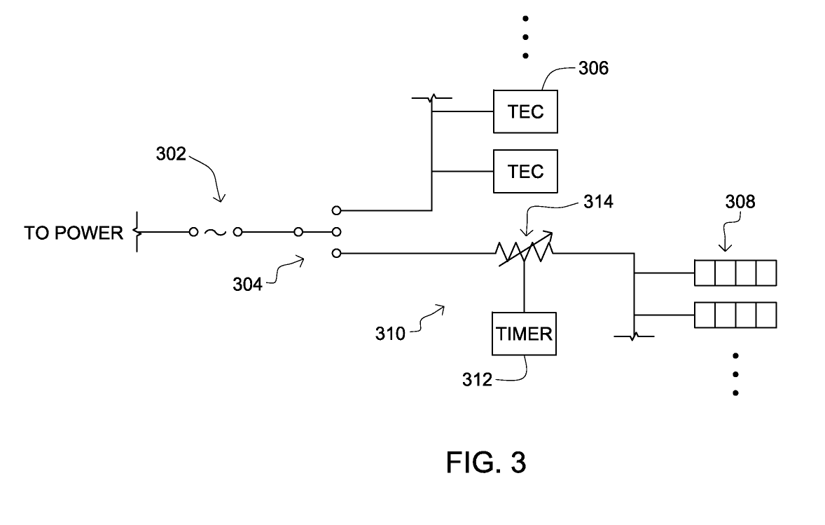

FIG. 3 is a component diagram illustrating a climate control system according to one embodiment of the invention. There is shown a switch 304 (control module) coupled to a motorcycle and accessible to a user. The switch 304 is in communication with the alternator 302 of the motorcycle and to the power source (battery) thereof. Accordingly, the switch controls delivery of power to other portions of the system. The illustrated switch is a three position switch that can restrict access to power or deliver power to each of two portions of the circuit.

There is also shown a set of heating elements 308 (heating module) coupled to an interface of the motorcycle and functionally coupled to the switch 304. Heating elements generate heat when electricity flows through them. The flow of electricity through the heating elements is further controlled by the illustrated timer module 310 (part of the control module) including a variable resistor and a timer circuit controlling the variable resistor. Accordingly, when the switch is activated to provide power to the heating elements, the variable resistor is set to a first setting and the timer starts. When the timer reaches a predetermined setting, the timer changes the variable resistor resistance (increase) and thereby alters the electricity flow to the heating elements. This decreases the heat output of the heating elements. Accordingly, the heating module comprises a first heating mode and a second heating mode that is of a lower heat flow than the first heating mode wherein the control module automatically switches to the second heating mode after a programmed time elapses from actuation of the first heating mode.

Further, in the illustrated embodiment, there is a cooling module including a plurality of TEC modules 306 (thermo-electric coolers, heat pumps) coupled to an interface portion of the motorcycle and functionally coupled to the control module. The TEC modules generate a heat differential between plates when current flows therethrough. Accordingly, when the switch causes electricity to flow through the TEC modules, the TEC module pump heat from one surface to another surface, thereby generating a cold surface which is in contact with the interface portion of the motorcycle, thereby cooling the portion.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A climate control system for open-seat vehicles, comprising:
a control module coupled to the open-seat vehicle and accessible to a user;
a heating module operationally coupled to an interface portion of the open-seat vehicle and functionally coupled to the control module such that the control module may activate the heating module, the heating module including a device for converting power to heat when activated;
a timing module configured to automatically switch the heating module operation from a first heating mode to a second heating mode that is of a lower heat flow than the first heating mode after a programmed time elapses from actuation of the first heating mode; and
a cooling module coupled to an interface portion of the open-seat vehicle and functionally coupled to the control module such that the control module may activate the cooling module, the cooling module including a device for utilizing power to remove heat.

2. The climate control system of claim 1, wherein the interface portion is selected from the group consisting of handles, seat, and foot rest.

3. The climate control system of claim 2, wherein the control module is coupled to the handles and accessible therefrom.

4. The climate control system of claim 1, wherein the system comprises a retrofit kit configured to be added to a open-seat vehicle, including mounting devices for mounting the control module to handles of the open-seat vehicle and mounting devices for mounting the heating and cooling modules to interface portions of the open-seat vehicle.

5. A retro-fit climate control system for open-seat vehicles, consisting essentially of:
a control module coupled to the open-seat vehicle and accessible to a user;
a heating module operationally coupled to an interface portion of the open-seat vehicle and functionally coupled to the control module such that the control module may activate the heating module, the heating module including a device for converting power to heat when activated;
a timing module configured to automatically switch the heating module operation from a first heating mode to a second heating mode that is of a lower heat flow than the first heating mode after a programmed time elapses from actuation of the first heating mode;
a cooling module coupled to an interface portion of the open-seat vehicle and functionally coupled to the control module such that the control module may activate the cooling module, the cooling module including a device for utilizing power to remove heat; and
a retrofit kit including mounting devices for mounting the control module to handles of the open-seat vehicle and mounting devices for mounting the heating and cooling modules to interface portions of the open-seat vehicle.

6. The climate control system of claim 5, wherein the interface portion is selected from the group consisting of handles, seat, and foot rest.

7. The climate control system of claim 6, wherein the control module is coupled to the handles and accessible therefrom.

8. The climate control system of claim 5, wherein the system comprises a retrofit kit configured to be added to a open-seat vehicle.
